(19) United States
(12) Patent Application Publication
(10) Pub. No.: US 2015/0378812 A1
(43) Pub. Date: Dec. 31, 2015

(54) System and Method for Error Recovery in an Asynchronous FIFO

(71) Applicant: Emulex Corporation, Costa Mesa, CA (US)

(72) Inventor: Shiro Suzuki, Folsom, CA (US)

(21) Appl. No.: 14/316,435

(22) Filed: Jun. 26, 2014

(51) Int. Cl. G06F 11/10

(52) U.S. Cl. CPC G06F 11/10

(57) ABSTRACT

A system and method for error recovery in an asynchronous first-in, first-out device (FIFO) are described herein. The FIFO may comprise a FIFO memory that is controlled with a FIFO controller. In accordance with this disclosure, the FIFO memory may receive input data, temporarily store the input data, and transmit the temporarily stored input data as output data. The FIFO controller comprises a plurality of control registers. During operation, the FIFO controller may detect a bit error in a control register of the plurality of control registers and set a flag associated with the output data. The FIFO controller may subsequently correct the bit error without requiring a reset to a system environment comprising the FIFO.

### FIELD

The disclosure relates to the field of memory controllers. In particular, but not exclusively, it relates to a system and method operable to provide error detection and recovery in a memory controller of an asynchronous FIFO.

### BACKGROUND

First-In, first-out (FIFO) refers to a queue processing technique for organizing and transferring data on a first-come, first-served basis. FIFO may also refer to a device that performs the queue processing. Data received by a FIFO is added to a queue data structure, and the first data which is added to the queue is the first data to be removed. FIFO queue processing may proceed sequentially. A FIFO device may be used for synchronization purposes in computer and CPU hardware. A FIFO is generally implemented as a circular queue, and thus has a read pointer and a write pointer. A synchronous FIFO uses the same clock for reading and writing. An asynchronous FIFO uses separate clocks for reading and writing and may be managed by a FIFO controller that maintains pointers via internal registers.

A bit error in the data written to and read from the FIFO may be detectable by adding parity bits to the data path. However, errors in the FIFO controller registers may not be detectable by merely adding such parity bits in the data path.

A soft error may occur when a bit in a FIFO controller register is in error. The soft error in the FIFO controller register may result in data corruption. For example, data may be written to or read from the wrong location in the FIFO memory. If valid data was accessed from the wrong location in the FIFO, parity in the FIFO data path would not detect this situation. Parity protection of the FIFO controller registers has been used. However, once a single soft error (e.g., bit upset) within the FIFO controller is detected with this method, the entire system comprising the FIFO and the FIFO controller must be stopped and reset to avoid the resulting data corruption from propagating. The stopping and resetting causes the entire system to be unavailable in the event of a single bit upset in the FIFO controller.

Further limitations and disadvantages of conventional and traditional approaches will become apparent to one of skill in the art, through comparison of such systems with the present disclosure as set forth in the remainder of the present disclosure with reference to the drawings.

### BRIEF SUMMARY

Aspects of the present disclosure are aimed at a system and method for error recovery in an asynchronous first-in, first-out device (FIFO). In accordance with this disclosure, the FIFO may recover from a bit error in a control register without requiring a full reset.

One example embodiment of this disclosure comprises a FIFO memory and a FIFO controller having a plurality of control registers. The FIFO memory is operable to receive input data, temporarily store the input data, and transmit the temporarily stored input data as output data. The FIFO controller is operable to detect a bit error in a control register, set a flag associated with the output data, and correct the bit error.

In another example embodiment of this disclosure, the flag indicates that that the output data may be corrupt.

In another example embodiment of this disclosure, the bit error is corrected after all of the temporarily stored input data is transmitted. The FIFO controller may indicate that the FIFO memory is full until all of the temporarily stored input data is transmitted.

In another example embodiment of this disclosure, the bit error may be detected by checking a parity bit associated with the control register of the plurality of control registers.

In another example embodiment of this disclosure, an error may be detected by checking a parity bit associated with the control register of the plurality of control registers.

In another example embodiment of this disclosure, one or more of the plurality of control registers may be Gray-coded.

In another example embodiment of this disclosure, the control register with the detected bit error may be held in an error state until an acknowledgement is returned.

In another example embodiment of this disclosure, the plurality of control registers comprises one or more write pointer(s), read pointer(s), write counter(s), and read counter(s).

In another example embodiment of this disclosure, upon detecting a bit error in a write counter, the write counter is held in an error state until a read pointer matches a write pointer.

This disclosure also describes a method comprising receiving input data, temporarily storing the input data in a first-in, first-out (FIFO) device, detecting a bit error in a control register associated with the FIFO device, setting a flag associated with the temporarily stored input data, and correcting the bit error in the control register.

Another method of this disclosure comprises outputting the temporarily stored input data asynchronously with respect to receiving the input data.

Another method of this disclosure comprises discarding the temporarily stored input data while the flag is set.

Another method of this disclosure comprises removing all of the temporarily stored input data from the FIFO before the bit error in the control register is corrected.

Another method of this disclosure comprises indicating the FIFO device is full until all of the temporarily stored input data is transmitted.

Another method of this disclosure comprises checking a parity bit associated with the control register to detect a bit error.

Another method of this disclosure comprises detecting a bit error in a write counter and holding the write counter in an error state until a read pointer matches a write pointer.

### BRIEF DESCRIPTION OF SEVERAL VIEWS OF THE DRAWINGS

FIG. 1 is a block diagram of a system operable to indicate a soft error in a FIFO controller according to one or more example embodiment(s) of the present disclosure.

FIG. 2 is a block diagram of an error recovery system for detecting and recovering from a single bit upset in the FIFO controller according to one or more example embodiment(s) of the present disclosure.

FIG. 3 is a block diagram of an error recovery system that illustrates the detection and correction of a soft error in a write pointer of a FIFO controller according to one or more example embodiment(s) of the present disclosure.

FIG. 4 is a series of timing diagrams associated with the detection and correction of a soft error in a write pointer of a FIFO controller according to one or more example embodiment(s) of the present disclosure.

FIG. 5 is a block diagram of an error recovery system that illustrates the detection and correction of a soft error in a write counter of a FIFO controller according to one or more example embodiment(s) of the present disclosure.

### DETAILED DESCRIPTION

This disclosure provides a system and method for detecting and correcting data corruption due to a single bit upset in a register within a FIFO controller. The system and method of this disclosure adds single bit upset detection capability to the registers in a FIFO controller and subsequently self-corrects the corrupted register value such that normal FIFO operation can resume. By self-correcting the FIFO controller registers, the system and method of this disclosure does not require a full reset on a single bit upset. Avoiding a device reset after a soft error improves system availability.

Furthermore, the self-correction provided by the FIFO controller in this disclosure is transparent when the FIFO is inactive.

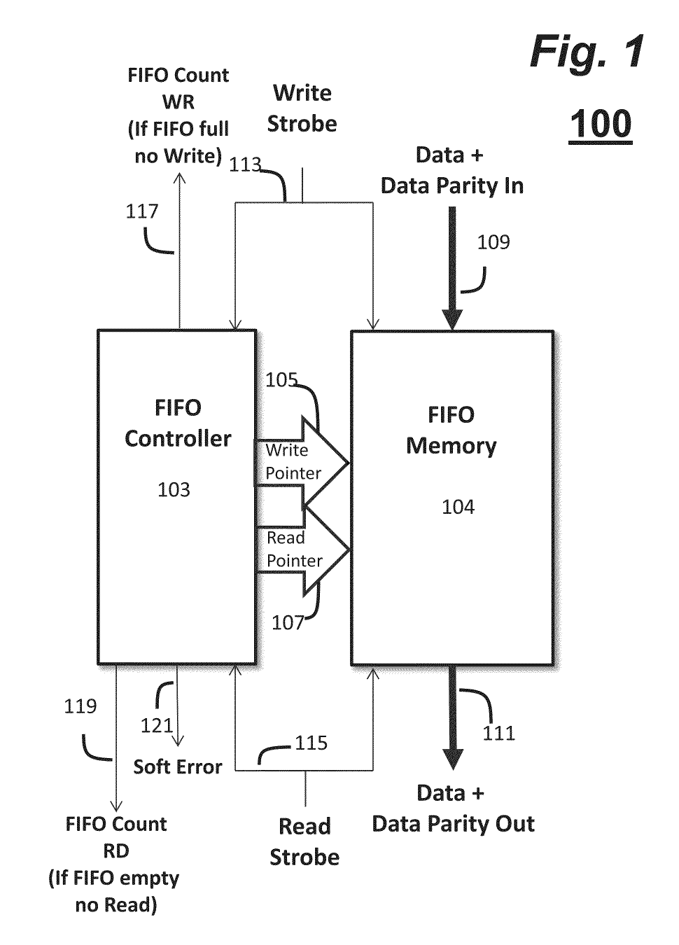

FIG. 1 is a block diagram of a system operable to indicate a soft error in a FIFO 100 according to one or more example embodiment(s) of the present disclosure. The FIFO 100 comprises a FIFO controller 103 and a FIFO memory 104. Data+Data Parity In 109 is written to the FIFO memory 104, and Data+Data Parity Out 111 is read from the FIFO memory 104. Data+Data Parity In 109 and Data+Data Parity Out 111 may be protected by a coding scheme that enables the detection and/or correction of errors in the data that passes though the FIFO. An example of such a coding scheme is the addition of one or more bits of a parity code. Downstream logic may discard such additional bits.

The FIFO controller 103 manages a write pointer 105 and a read pointer 107 to the FIFO memory 104. The FIFO controller 103 may comprise a write section (WR) that is clocked by a write strobe 113 (WRCLK) and a read section (RD) that is clocked by a read strobe 115 (RDCLK). The FIFO 100 may operate asynchronously. For example, the write strobe 113 may not be synchronized to the read strobe 115.

The FIFO controller may also comprise a FIFO Count WR 117 in and a FIFO Count RD 119. The FIFO Count WR 117 may indicate if the FIFO memory 104 is full, thereby preventing Data+Data Parity In 109 from being written to the FIFO memory 104. The FIFO Count RD 119 may indicate if the FIFO memory 104 is empty, thereby preventing Data+Data Parity Out 111 from being read from the FIFO memory 104. Even if the write pointer 105 was corrupt, the FULL status may be determined from the FIFO Count WR 117. Likewise, if the read pointer 107 was corrupt, the EMPTY status may be determined from the FIFO Count RD 119.

A single bit upset in a register of either the read or the write section of the FIFO controller 103 may be detected and flagged as a soft error flag 121. The soft error flag 121 indicates that Data+Data Parity Out 111 may be corrupt. Subsequently, the FIFO controller 103 may update internal registers such that the FIFO memory 104 may resume operation without a reset. Downstream logic may determine data validity according to an error in Data+Data Parity Out 111 and/or the soft error flag 121.

If the FIFO controller 103 detects a soft error flag 121, the FIFO controller 103 sets the FIFO Count WR 117 to indicate the FIFO memory 104 is FULL, thereby preventing further data from entering the FIFO memory 104. All of the data in the FIFO memory 104 may be flagged as being potentially in error. Once the FIFO memory 104 is empty, normal operation may be resumed and the soft error flag 121 may be cleared.

The logic downstream of the FIFO sees that Data+Data Parity Out 111 is unreliable and needs to be discarded. For example, if a Fibre Channel frame is passing thru the FIFO memory 104 and a soft error flag 121 is detected, an End of Frame (EOF) may be changed to an End of Frame abort (EOFa). The logic downstream of the FIFO may discard all EOFa frames. Similarly, Ethernet frames may be flagged as corrupt when a soft error is indicated. The rate of soft errors may be low, such that discarding a whole frame if a soft error occurs is acceptable. Furthermore, if the FIFO is empty when the soft error occurred, the soft error may be ignored.

The FULL and EMPTY flags are each synchronous with one of the counters. The EMPTY flag is synchronous with the FIFO Count RD 119, and the FULL flag is synchronous with the FIFO Count WR 117. If a “new” comparison value for a pointer is missed because the read and write strobes are asynchronous, the FIFO merely stays FULL or EMPTY one cycle longer, but this does not cause an error. This is because going FULL or EMPTY is synchronous, but when either flag goes inactive, it is because of the other clock domain (an asynchronous operation), and staying FULL or EMPTY one cycle longer than necessary is not a problem.

For the EMPTY condition, there are two transitions: the beginning of the EMPTY signal (e.g., “don't read any more”) and the end of the EMPTY signal (e.g., “it's ok to read again”).

In the beginning of the EMPTY signal, the path from the read address to the EMPTY flag is synchronous, since both are clocked by the read clock. The write clock has nothing to do with this transition, so this portion of the operation is synchronous, and metastability is no issue.

The ending of the EMPTY signal is an asynchronous event, since it is initiated by a write clock, and must be interpreted by the read clock. However, the interpretation need not be precise. In the worst case, there is an unnecessary extra wait state before reading the next word.

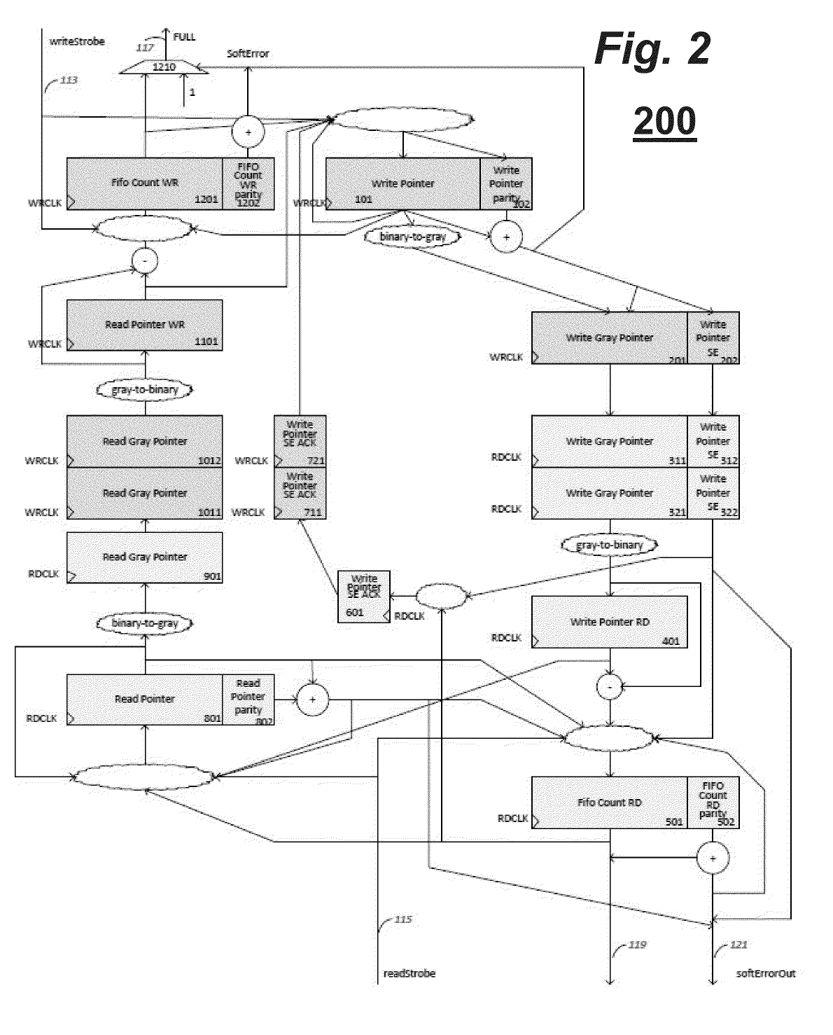

FIG. 2 is a block diagram of an error recovery system 200 for detecting that output data (Data+Data Parity Out) may be corrupt as a result of a single bit upset in the FIFO controller 103 of FIG. 1. The error recovery system 200 may enable the detection of a single bit upset in the FIFO controller 103 of FIG. 1. Upon detection of the single bit upset, the error recovery system 200 may set a flag to indicate that output data (Data+Data Parity Out) may be corrupt, and the error recovery system 200 may update internal registers so that the FIFO operation may resume without a reset.

In one embodiment, the FIFO controller 200 may comprise: a plurality of registers associated with a write pointer (e.g., Write Pointer 101, Write Gray Pointer 201, Write Gray Pointer 311, Write Gray Pointer 321, and Write Pointer RD 401); a register associated with a read counter (e.g., FIFO Count RD 501); a plurality of registers associated with a read pointer (e.g., Read Pointer 801, Read Gray Pointer 901, Read Gray Pointer 1011, Read Gray Pointer 1012 and Read Pointer WR 1101); and a register associated with a write counter (e.g., FIFO Count WR 1201).

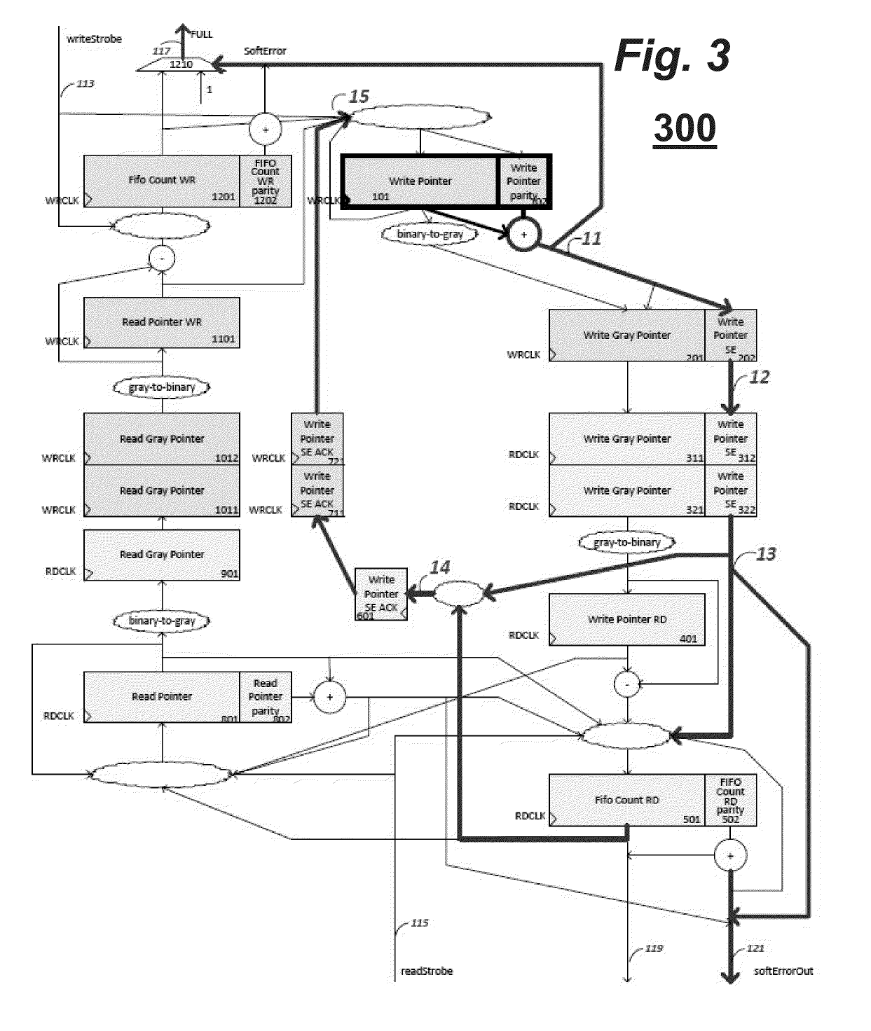

As illustrated in FIGS. 2 and 3, “Gray Pointers” refer to a Gray-coded format. Although Write Gray Pointer 201, Write Gray Pointer 311, Write Gray Pointer 321, Read Gray Pointer 901, Read Gray Pointer 1011 and Read Gray Pointer 1012 are shown, pointers having any other format are within the scope of this disclosure. Furthermore, it is within the scope of this disclosure to replace Write Gray Pointer 311 and Write Gray Pointer 321 with one or more similar registers to change the synchronization delay. Likewise, it is within the scope of this disclosure to replace Read Gray Pointer 1011, and Read Gray Pointer 101 with one or more similar registers to change the synchronization delay.

Write Pointer 101, Write Gray Pointer 201, Read Gray Pointer 1011, Read Gray Pointer 1012, Read Pointer WR 1101, and FIFO Count WR 1201 may be clocked by a clock signal synchronous to the write strobe (WRCLK) 113. Write Gray Pointer 311, Write Gray Pointe 321, Write Pointer RD 401, Read Pointer 801, Read Gray Pointer 901, and FIFO Count RD 501 may be clocked by a clock signal synchronous to the read strobe (RDCLK) 115.

Write Pointer 101, Read Pointer 801, FIFO Count RD 501, and FIFO Count WR 1201 may each be associated with a parity bit (Write Pointer parity 102, Read Pointer parity 802, FIFO Count RD parity 502 and FIFO Count WR parity 1202 respectively) for error detection.

Write Pointer 101 and Read Pointer 801 may be converted from binary format to Gray-coded format to generate Write Gray Pointer (WGP) 201 and Read Gray Pointer (RGP) 901 respectively. When a pointer is Gray-coded, sequential pointer values differ in only one bit position. For example, the binary sequence {00, 01, 10, 11, 00, 01 . . . } differs in two bit positions when comparing “01” and “10.” However, the Gray-coded sequence {00, 01, 11, 10, 00, 01 . . . } differs in only one bit position when comparing any two sequential values.

If a Soft Error is detected on Read Pointer 801, the Read Pointer 801 may be reset to the sum of Write Pointer RD 401 and FIFO Count RD 501.

If a Soft Error is detected on FIFO Count RD 501, FIFO Count RD 501 may be reset to the difference between Write Pointer RD 401 and Read Pointer 801 (e.g., Write Pointer RD 401−Read Pointer 801) when a soft error is detected.

The Write Gray Pointer registers 311 and 321 and the Read Gray Pointer registers 1011 and 1012 can be protected from single upset events by doubling the width and sending two copies of the corresponding Gray Pointer. If the two copies match on the destination, no soft error is indicated. If the two copies differ by only one bit at the destination, the destination should use the Gray Pointer closer to the previous pointer value. In this case, either the pointer did not change but a soft error occurred, or a pointer did change but a soft error occurred on the changing bit. If the two copies different for more than one bit, a soft error has occurred and the destination should ignore the Gray Pointer.

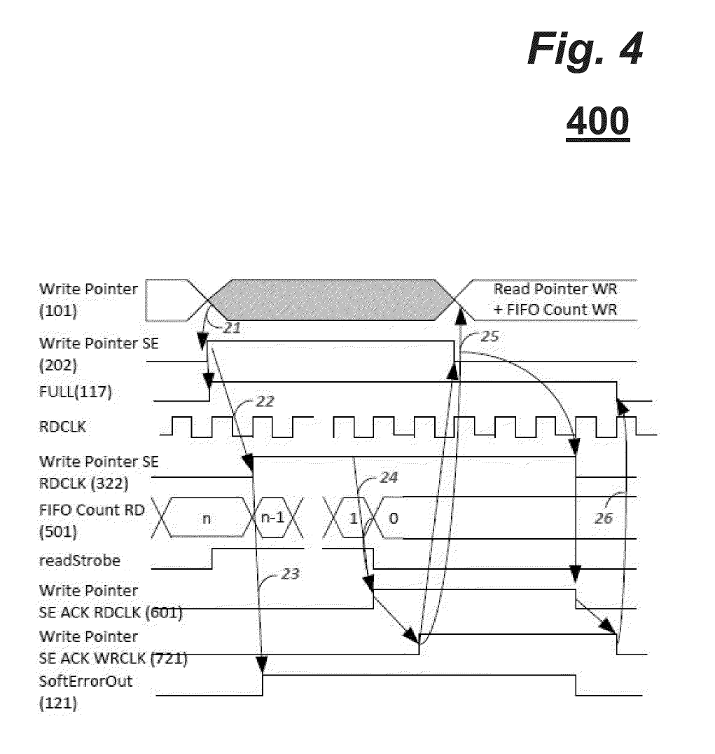

FIG. 3 is a block diagram of an error recovery system 300 that illustrates the detection and correction of a soft error in a write pointer of a FIFO controller according to one or more example embodiment(s) of the present disclosure. FIG. 4 is a series of timing diagrams 400 associated with the detection and correction of a soft error in a write pointer of a FIFO controller according to one or more example embodiment(s) of the present disclosure.

If an error is detected, the Write Pointer 101 and Write Pointer Parity 102 are held in an error state at line 11. The Write Pointer 101 and Write Pointer Parity 102 are released from the error state when a Write Pointer Soft Error Acknowledgement (SE ACK) 721 is returned at line 15. While the Write Pointer 101 is in error state, the FIFO Count WR output 117 indicates that the FIFO is FULL to prevent further writes to the FIFO to occur. The FIFO Count WR 117 may indicate that the FIFO is FULL even though the FIFO may not actually be full. The timing relationship 21 is illustrated in FIG. 4, where the Write Pointer SE signal 202 transitions from low to high and the FULL indication 117 transitions from low to high since the Write Pointer SE signal 202 selects “1” at a switch 1210 (e.g., FIGS. 2-3 and 5).

At line 12 of FIG. 3, WGP 201 is held as long as Write Pointer Parity 202 is in error. This also assures that further writes to the FIFO cannot propagate to the read side. The Write Pointer SE flag 202 is passed to the read side downstream logic and synchronized, though one or more registers 312 and 322 (e.g., FIG. 3), to the read clock domain. Due to a synchronization delay of the Write Pointer SE pointer 322, the read side logic may indicate that one or more pieces of data already read out are bad. The synchronization delay of the Write Pointer SE pointer 322 is illustrated in FIG. 4 by the relationship 22 between the Write Pointer SE 202 and the Write Pointer SE RDCLK 322.

While the Write Pointer SE signal 322 is asserted, the soft error flag (SoftErrorOut) 121 is asserted at line 13 of FIG. 3, and the output data read from the FIFO (Data+Data Parity Out) may be discarded. Also, the read side logic can ignore the Write Pointer SE signal if the read logic is inactive. The assertion of SoftErrorOut 121 is illustrated in FIG. 4 by the relationship 23 between the Write Pointer SE RDCLK 322 and SoftErrorOut 121.

Logic downstream continues to read the FIFO while the FIFO is not empty. When the FIFO is empty there is no data in the memory and hence the recovery of the Write Pointer 101 can start at line 14 of FIG. 3. As shown in FIG. 3, Write Pointer SE ACK signal 601 may be generated once the FIFO side goes empty and the recovery begins. This acknowledgement is illustrated in FIG. 4 by the relationship 24 where FIFO Count RD 501 goes to “0” and Write Pointer SE ACK signal 601 transitions from low to high.

The Write Pointer SE ACK 601 is synchronized into the write clock domain. The Write Pointer SE ACK 721 in the write portion of the FIFO controller allows the Write Pointer 101 and the Write Pointer Parity 102 to be reset to Read Pointer WR 1201+FIFO Count WR 1101 at line 15 of FIG. 3. The reception of the acknowledgement is illustrated in FIG. 4 by the relationship 25 where transitioning the Write Pointer SE ACK signal 601 from low to high clears the Write Pointer SE 202 and resets the Write Pointer 101.

As illustrated by the transition 26 in FIG. 4, error signals (e.g., Write Pointer SE RDCLK 322, Write Pointer SE ACK RDCLK 601, Write Pointer SE ACK WRCLK 711, Write Pointer SE ACK WRCLK 721, SoftErrorOut 121 and FULL indicator 117) are cleared and FIFO returns to operational state when the Write Pointer 101 is reset.

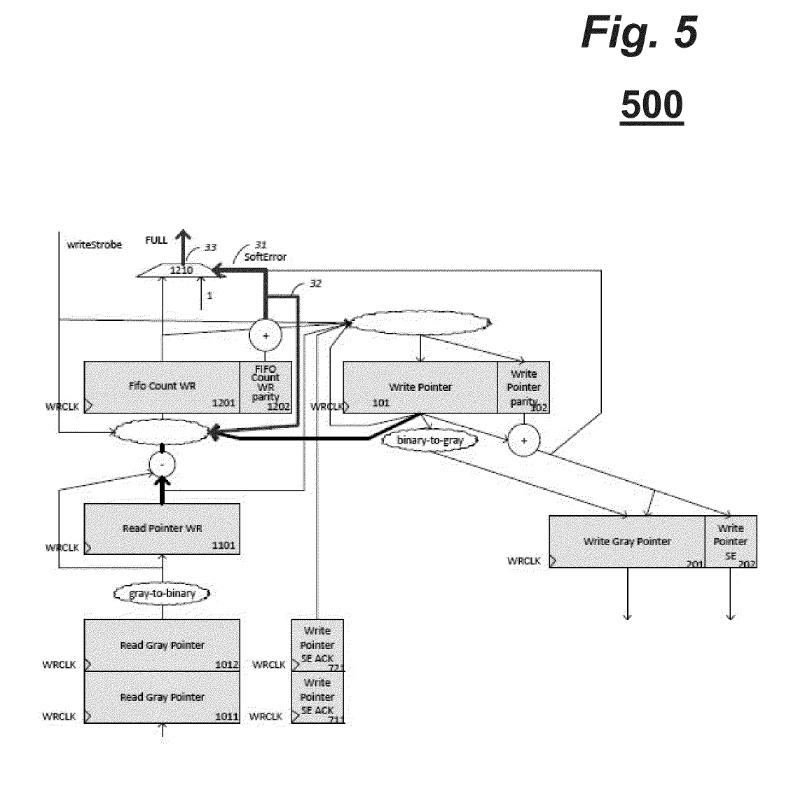

FIG. 5 is a block diagram of an error recovery system that illustrates the detection and correction of a soft error in a write counter of a FIFO controller according to one or more example embodiment(s) of the present disclosure.

As shown in FIG. 5, FIFO Count WR 1201 and FIFO Count WR Parity 1202 are held in error state until Read Pointer WR 1101 and Write Pointer 101 match. While the FIFO Count WR 1201 is in error state, the FIFO Count WR output is forced to FIFO full at line 31 to prevent further writes to the FIFO to occur.

FIFO Count WR 1201 and the FIFO Count WR Parity 1202 are reset to indicate FIFO empty (e.g. 0) when Read Pointer WR 1101 and Write Pointer 101 match at line 32. The read side logic operates as if no error occurred hence eventually the Read Pointer and Write Pointer match, and the FIFO returns to the operational state.

The present disclosure may be embedded in a computer program product, which comprises all the features enabling the implementation of the example embodiments described herein, and which when loaded in a computer system is able to carry out these example embodiments. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain example embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular example embodiment disclosed, but that the present disclosure will include all example embodiments falling within the scope of the appended claims.

What is claimed is:

1. A system comprising:
a first-in, first-out (FIFO) memory operable to receive input data; temporarily store the input data; and transmit the temporarily stored input data as output data; and
a FIFO controller comprising a plurality of control registers, the FIFO controller being operable to detect a bit error in a control register of the plurality of control registers, set a flag associated with the output data and correct the bit error.

2. The system of claim 1, wherein the FIFO controller is asynchronous.

3. The system of claim 1, wherein the flag indicates that that the output data may be corrupt.

4. The system of claim 1, wherein one ore more of the plurality of control registers is Gray-coded.

5. The system of claim 1, wherein the bit error is corrected after all or a substantial portion of the temporarily stored input data is transmitted.

6. The system of claim 5, wherein the FIFO controller indicates that the FIFO memory is full until all or a substantial portion of the temporarily stored input data is transmitted.

7. The system of claim 1, wherein the bit error is detected by checking a parity bit associated with the control register of the plurality of control registers.

8. The system of claim 1, wherein the control register of the plurality of control registers is held in an error state until an acknowledgement is returned.

9. The system of claim 1, wherein the plurality of control registers comprises a write pointer.

10. The system of claim 1, wherein the plurality of control registers comprises a read pointer.

11. The system of claim 1, wherein the plurality of control registers comprises a write counter.

12. The system of claim 11, wherein, upon detecting a bit error in the write counter, the write counter is held in an error state until a read pointer matches a write pointer.

13. The system of claim 1, wherein the plurality of control registers comprises a read counter.

14. A method comprising:
receiving input data;
temporarily storing the input data in a first-in, first-out (FIFO) device;
detecting a bit error in a control register associated with the FIFO device;
setting a flag associated with the temporarily stored input data; and
correcting the bit error in the control register.

15. The method of claim 14, wherein the method comprises outputting the temporarily stored input data asynchronously with respect to receiving the input data.

16. The method of claim 14, comprising discarding the temporarily stored input data while the flag is set.

17. The method of claim 14, wherein the bit error is corrected after removing all or a substantial portion of the temporarily stored input data from the FIFO device.

18. The method of claim 14, comprising indicating the FIFO device is full until all or a substantial portion of the temporarily stored input data is transmitted.

19. The method of claim 14, wherein detecting the bit error comprises checking a parity bit associated with the control register.

20. The method of claim 14, wherein the control register is a write counter and the method comprises holding the write counter in an error state until a read pointer matches a write pointer.
